(19) United States
(12) Patent Application Publication
(10) Pub. No.: US 2014/0150179 A1
(43) Pub. Date: Jun. 5, 2014

(54) HEATED AIR CUSHION COVER

(71) Applicant: Herbert Gawarecki, Haltern am See (DE)

(72) Inventor: Herbert Gawarecki, Haltern am See (DE)

(73) Assignee: GFM Ingenieur-und Produktionstechnik GmbH, Oer-Erkenschwick (DE)

(21) Appl. No.: 14/116,869

(22) PCT Filed: May 11, 2012
(86) PCT No.: PCT/EP2012/002045

§ 371 Date: Feb. 20, 2014

(30) Foreign Application Priority Data
May 11, 2011 (DE) 10 2011 101 290.0

(51) Int. Cl. A47G 9/02; B32B 7/04; B32B 3/28

(52) U.S. Cl. CPC A47G 9/0215; B32B 3/28; B32B 7/04
USPC 5/423; 156/87; 156/73.1

(57) ABSTRACT

A heated air cushion cover, especially for heat regulation of patients during surgeries, having at least one first material layer connected to at least perforated second material layer so as to form at least one hollow chamber through which an air stream can flow to the outer, patient side of the second material layer is improved by a homogeneous warm air output being produced on the patient side. The homogeneous warm air output is attained by an air-permeable third material layer being at least partially connected to the outer side of the second material layer. The third material layer diffusely distributes the air stream penetrating the perforations of the second material layer upon passing through the third material layer.

### BACKGROUND OF THE INVENTION

1. Field of the Invention

The invention relates to a heated air cushion cover with at least one first material layer, at least one second material layer and with an air inlet opening, the first material layer and the second material layer being connected to one another such that, when the heated air cushion cover is supplied with an air stream via the air inlet opening between the first material layer and the second material layer, at least one cavity is formed through which the air stream can flow, at least the second material layer having a perforation via which the air can emerge from the cavity onto the outside of the second material layer. The invention moreover also relates to a method for producing this heated air cushion cover.

2. Description of Related Art

Heated air cushion covers of the initially mentioned type have been known for a long time; they are used mainly to supply heat to a patient during surgery or also postoperatively via an air stream so that unwanted cooling and lowering of the body temperature are avoided. Heated air cushion covers are known in quite different versions; they surround the patient over as large an area as possible, and of course, they must not cover the areas which are necessarily accessible during a surgery; in this respect, depending on the application, there are heated air cushion covers of different shapes.

The heated air cushion cover is conventionally supplied with a temperature-controlled air stream via the air inlet opening, the pressure build-up in the cavity between the first material layer and the second material layer leading to its forming an air cushion. The second material layer which has a perforation is facing the patient in use so that a host of small “nozzles” is formed via the discrete outlet openings in the second material layer in order that the patient is surrounded not only by a warm air cushion, but in fact also by a warm air stream.

It is problematical in the heated air cushion covers known from the prior art that the holes which form the perforation form narrowly bounded flow openings which are located in the immediate vicinity of the patient so that local and narrowly bounded skin sites of the patient are exposed to a jet of warm air over the interval of application; this can be perceived as unpleasant and leads to a “measles effect,” i.e., reddened skin sites in the region of the perforation.

### SUMMARY OF THE INVENTION

The primary object of this invention is to devise a heated air cushion cover which offers increased comfort of wearing while avoiding the above described “measles effect”.

The aforementioned object is achieved in the generic heated air cushion cover, first of all, essentially in that there is an air-permeable third material layer on the outside of the second material layer which is at least partially connected to the second material layer. The third material layer diffusely distributes the air stream passing through the perforations of the second material layer as it passes through the third material layer. This surprisingly simple measure can greatly increase the comfort of wearing the heated air cushion cover, and it must always be watched that the air-permeable third material layer, which is connected to the second material layer, does in fact also lead to a diffuse distribution of the air stream from the holes of the second material layer. Since the second and third material layers, is not the case if they have overlapping perforations; i.e., when the second and third material layers, together, are jointly perforated as a material layer combination. So that the required diffuse distribution of the air stream by the third material layer takes place, the effective air passage area of the third material layer must, as much as possible, be many times larger than the air passage area through the perforation of the second material layer.

In one preferred configuration of the invention, this is achieved by the third material layer being an air-permeable textile fabric, preferably in the form of a fleece or nonwoven fabric. For the applications considered here with increased hygiene requirements, a fleece is advantageous as compared to felt or cellulose product due to its much larger fiber length which provides a minimal danger of fibers working loose. An unconsolidated fleece is then suitable mainly as the third material layer when it is joined flat to the second material layer, even then an effectively diffuse distribution of the air stream is achieved.

When using tighter or consolidated textile fabrics as the third material layer, as a preferred configuration of the invention, it has especially proven itself that the second material layer and the third material layer are only partially connected to one another so that the air stream passing through via the perforations of the second material layer is distributed in at least one cavity between the second material layer and the third material layer and is first captured there. This measure causes a much better distribution effect of the air stream in which essentially a defined flow source can no longer be determined on the side of the third material layer facing the patient; in this way, the heated air cushion cover configured acts essentially as a homogenous flow surface.

In an advantageous configuration of the invention, the above described heated air cushion cover is implemented in that the third material layer is connected in an undulating manner and forms a cavity to the second material layer; this can be achieved, for example, by the second material layer, per unit of area of the heated air cushion cover, being smaller than the the third material layer so that the third material layer essentially bulges at the sites at which it is not connected to the second material layer. Depending on the desired extent of the bulging, the choice of area of the material used for the third material layer is goes 1.5% to 15% beyond the material used for the second material layer has proven to be suitable.

The above described heated air cushion covers in accordance with the invention with at least one first material layer, at least one second material layer and at least one third material layer, according to a teaching of the invention which relates to manufacture, are produced by the second material layer being elastically stretched and perforated, the stretched second material layer and the third material layer which has not been stretched or at least stretched less than the second material layer are combined and partially connected to one another. Then, the second material layer which is connected to the third material layer is relieved, and finally, the connected second material layer and third material layer are combined with the first material layer with the first material layer and the second material layer being partially connected to one another.

It is irrelevant to the invention whether the second material layer is already perforated when it is elastically stretched or this takes place before stretching or after stretching. Stretching of the second material layer and partially joining the stretched second material layer to the third material layer which has not been stretched result in that, in the relieved state of the second material layer, the third material layer necessarily undulates and bulges so that the combination of interconnected second and third material layer is soft and bulky. This production technique results in that the third material layer is connected in an undulating manner and forms a cavity to the second material layer because of the area of the second material layer covers a smaller area than that of the third material layer. The warm air passing through the perforations of the second material layer is first captured in the described cavities between the second material layer and the third material layer, and then, penetrates through the third material layer which is, inherently, permeable to air over a large area.

In particular, there are now various possibilities for configuring and developing the heated air cushion cover and the method for producing the heated air cushion cover in accordance with the invention. In this respect, reference is made to the description of preferred exemplary embodiments in conjunction with the accompanying drawings.

### BRIEF DESCRIPTION OF THE DRAWINGS

FIG. 1 is a perspective view of a heated air cushion cover known from the prior art,

FIG. 2 is a cross-sectional view of the prior art heated air cushion cover in the region of the perforations,

FIG. 3 is a sectional view of a heated air cushion cover in accordance with the invention in the region of the perforations,

FIG. 4 is a sectional view of another exemplary embodiment of a heated air cushion cover in accordance with the invention,

FIGS. 5a, 5b show two steps for producing a heated air cushion cover in accordance with the invention, and

FIGS. 6a, 6b show two exemplary embodiments of joined second and third material layers with hot melt bonds.

### DETAILED DESCRIPTION OF THE INVENTION

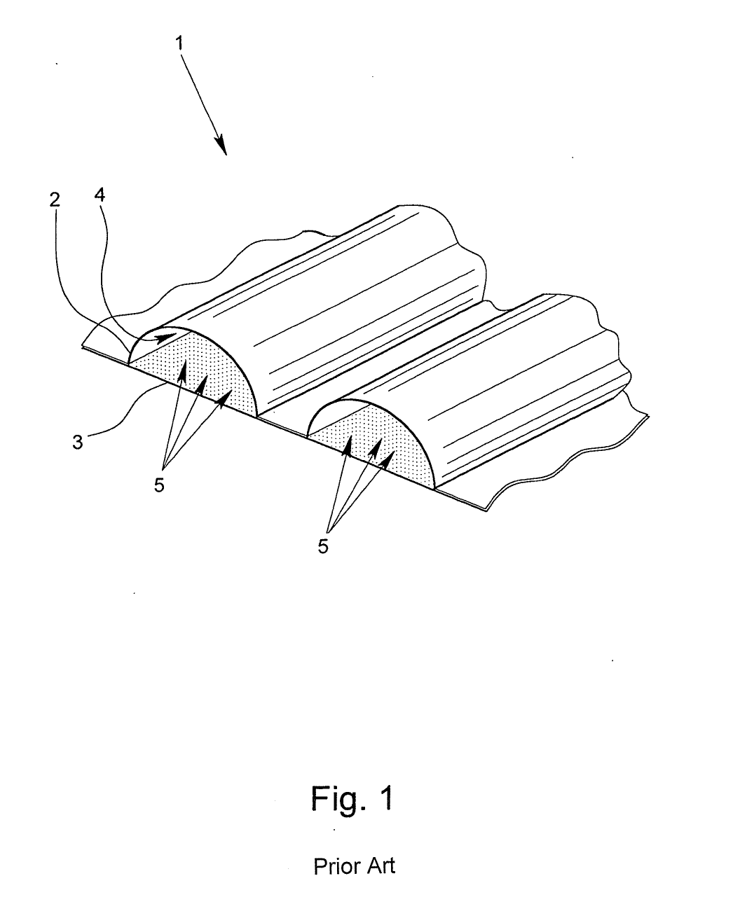

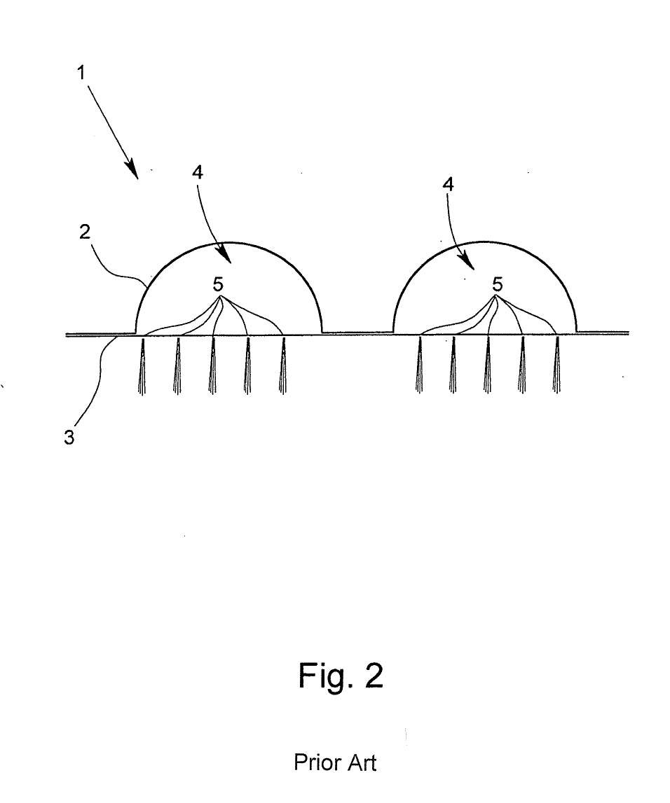

FIGS. 1 and 2 show a prior art heated air cushion cover 1 with a first material layer 2 and with a second material layer 3. The first material layer 2 and the second material layer 3 are joined to one another such that when the heated air cushion cover 1 is supplied with an air stream via an air inlet opening to a cavity 4 formed between the first material layer 2 and the second material layer 3, and through which the stream of air can flow. The second material layer 3 has perforations 5 via which the air from the cavity 4 can emerge o the outside of the second material layer 3, which faces the patient in normal applications. FIG. 2 shows that the perforations 5 in the second material layer 3 lead to bunched air streams, especially in the immediate exit region of the perforations 5. This can be perceived as unpleasant and leads in part to local skin irritations (“measles effect”) in patients since the patient comes into contact with a concentrated air stream in the region of the perforations.

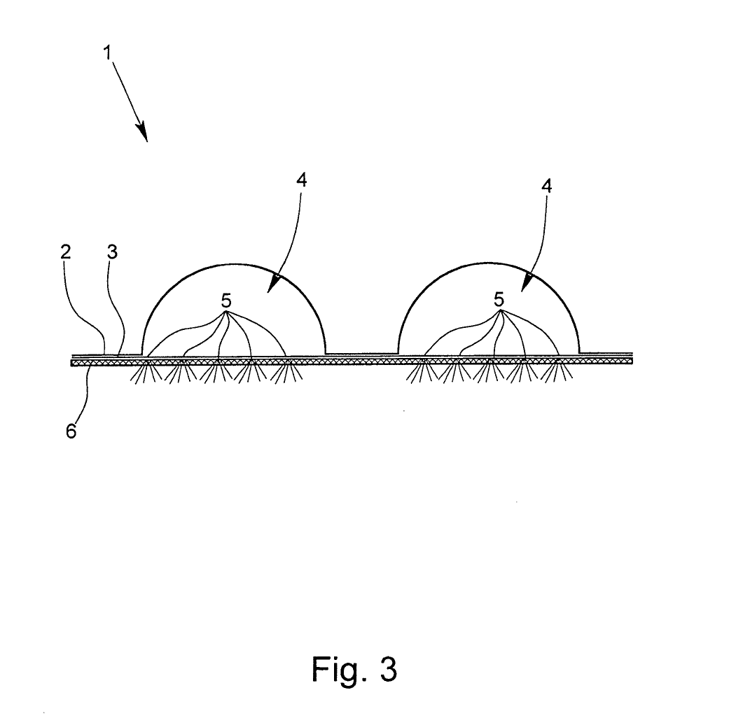

In the exemplary embodiments air cushion according to FIGS. 3 to 6, the above described problem is addressed by a third material layer 6 which is at least partially connected to the second material layer 3 being located on the outside of the second material layer 3 and by the third material layer 6 diffusely distributing the air stream passing through the perforations of the second material layer 3 as it passes through the third material layer 6.

The third material layer 6 in the exemplary embodiment according to FIG. 3 is applied flat to the second material layer 3 and is connected to it in a flat condition. Because the third material layer 6 is inherently air-permeable, the air stream through the perforations 5 in the second material layer 3 are diffusely distributed so that the flow exit surface is greatly enlarged as compared to the heated air cushion covers shown in FIGS. 1 and 2. The result is that the air stream emerging on the outside of the third material layer 6 is less concentrated and also is perceived as less concentrated so that this configuration does not lead to the above described “measles effect.”

In all illustrated exemplary embodiments, the first material layer 2 and the second material layer 3 are made of a polyethylene film and the third material layer 6 is a nonwoven fleece, or other nonwoven fabric, such as felt. The thickness of the polyethylene film is roughly 15μ; this is a good compromise between tear resistance and flexibility. The nonwoven fabric has a weight of 15 g/m², it having been ascertained that it achieved an overall effect of good wearing comfort but a diffuse distribution action for the air stream can be achieved in accordance with the invention with nonwovens in a weight range between 5 g/m² and 50 g/m².

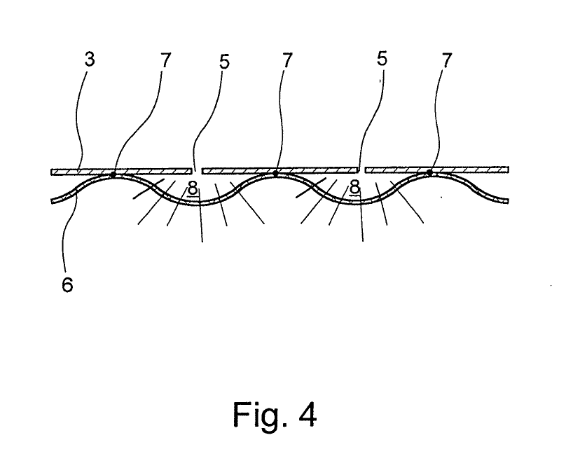

FIG. 4 shows a heated air cushion cover, here the first material layer no longer being explicitly shown. In the exemplary embodiments, the second material layer 3 and the third material layer 6 are only partially connected to one another, here specifically via a line of adhesive bonds 7. This leads to the air stream passing through the perforations 5 of the second material layer 3 into a cavity 8 being distributed between the second material layer 3 and the third material layer 6 and being released uniformly over the entire surface of the material layer 3 which borders the cavity 8 to the outside. This diffuse distribution of the air stream routed via the perforations 5, which has been effected in this way to the patient who is on the outside of the third material layer 6, produces an air stream which is essentially homogenous over the entire surface of the third material layer 6.

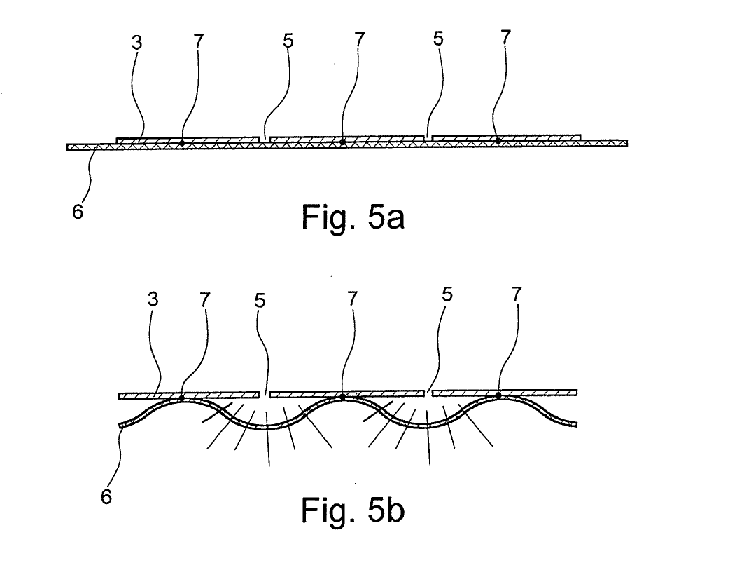

It applies to the exemplary embodiments according to FIGS. 4 and 5b that the third material layer 6 is connected in an undulating manner forming cavities in conjunction with the second material layer 3, here due to the second material layer 3 being smaller per unit of area of the heated air cushion cover than the that of the third material layer 6. This can be recognized from the fact that the second material layer 3 in FIGS. 4 and 5b runs essentially smoothly while the third material layer 6 is bulged.

The adhesive bonds 7 shown in FIGS. 4, 5a and 5b run parallel to one another and are spaced roughly 1 cm apart. The structure of the heated air cushion cover 1 which has been produced in this way results in an air flow discharge that is small enough so that the heated air cushion cover 1 is perceived as blanketing material. The air cushion between the first material layer 2 and the second material layer 3 can be more coarsely structured than the third material since they essentially do not come into direct contact with the patient.

FIGS. 5a & 5b schematically shows how the above described heated air cushion cover 1 is produced. In FIG. 5a, the second material layer 3 is elastically stretched and perforated. It is important that the stretching is elastic, therefore reversible, since the returning of the material to its unstretched size after relief is of great importance. The second material layer 3 has been stretched, here, by roughly 15%; as a result this necessitates use of an amount of the third material layer 6 is larger than the unstretched size of the second material layer 3 by this amount. The stretched second material layer 3 and the unstretched third material layer 6 are shown combined and partially joined to one another in FIG. 5a, likewise again, by adhesive bonds 7. Afterwards, the second material layer 3 is relieved with the result that the third material layer 6 bulges so as to form the cavities 8, as shown in FIG. 5b.

Finally, not shown in FIGS. 5a, 5b, is the second material layer 3 connected to the third material layer 6 which is combined with the first material layer 2.

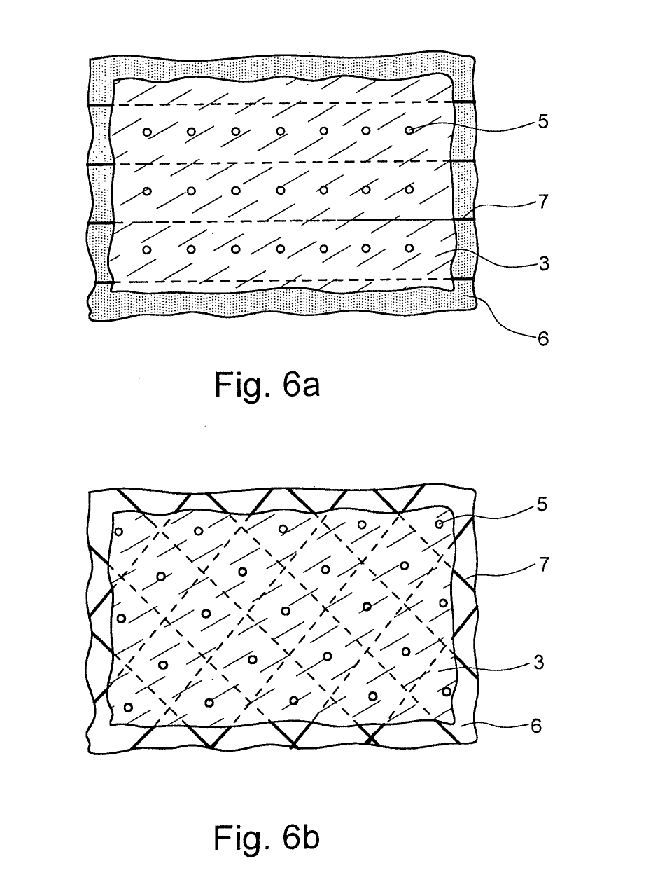

FIGS. 6a and 6b show different parallel connecting lines which are produced by adhesive bonds 7 and which have been produced, here, by lamination rolling. The version according to FIG. 6b, in which the connections are formed by two sets of parallel connecting lines which form a rhomboidal pattern has proven especially long-wearing.

1-11. (canceled)

12. A heated air cushion cover, comprising:
at least one first material layer,
at least one perforated second material layer,
air inlet opening,
wherein the first material layer is connected to the second material layer in a manner in which at least one cavity is formed through which a stream of air can flow from the air inlet opening and emerge from the at least one cavity to an outer side of the second material layer,
wherein an air-permeable third material layer is at least partially connected to the outer side of the second material layer, the air-permeable third material layer being able to diffusely distribute the air stream passing through the perforations of the second material layer as the air stream passes through the air-permeable third material layer.

13. The heated air cushion cover as claimed in claim 12, wherein the air-permeable third material layer is an air-permeable textile fabric.

14. The heated air cushion cover as claimed in claim 13, wherein the air-permeable textile fabric is in the form of a fleece or nonwoven material.

15. The heated air cushion cover as claimed in claim 13, wherein the air-permeable textile fabric has a weight between 5 g/m² and 50 g/m².

16. The heated air cushion cover as claimed in claim 13, wherein the air-permeable textile fabric has a weight between 15 g/m² and 25 g/m².

17. The heated air cushion cover as claimed in claim 12, wherein the second material layer and the third material layer are only partially joined to one another so that the air stream passing through via the perforation of the second material layer is distributed in at least one cavity between the second material layer and the third material layer.

18. The heated air cushion cover as claimed in claim 17, wherein the third material layer is joined to the second material layer in an undulating manner forming cavities between the second and third material layers.

19. The heated air cushion cover as claimed in claim 18, wherein the second material layer has a smaller area than that of the third material layer by about 1.5% to 15%.

20. The heated air cushion cover as claimed in claim 12, wherein at least one of the first material layer and the second material layer is a plastic film selected from the group consisting of polypropylene (PP), polyethylene (PE) and a mixture of polypropylene and polyethylene.

21. The heated air cushion cover as claimed in claim 12, wherein the second material layer and the third material layer are connected to one another along at least one set of connecting lines which run parallel to each other with adjacent connecting lines being spaced from one another by a distance of between 0.5 cm and 2 cm.

22. The heated air cushion cover as claimed in claim 21, wherein the at least one set of connecting lines comprises two sets of parallel connecting lines which form a rhomboidal pattern of connecting lines.

23. A method for producing the heated air cushion cover, comprising the steps of:
elastically stretching at least one second material layer and partially joining an air permeable third material layer to the elastically stretched second material layer,
then relaxing the stretching of the second material layer so that the second material layer returns to an area smaller than that of the third material layer so as to create undulations in the third material layer which form airs spaces between the second and third material layers, air flowing into said spaces via perorations of the second material layer being able to pass through the air permeable third layer in a diffused manner, and
then, partially connecting at least one first material layer to the at least one perforated second material layer in a manner forming at least one cavity through which a stream of air can flow from an air inlet opening and emerge from the at least one cavity through the perforations of the second material layer to the cavities between the perforated second material layer and the air permeable third material layer.

24. The method as claimed in claim 23, wherein the second material layer is elastically stretched by an amount between 1.5% and 15%.

25. The method as claimed in claim 24, wherein the second material layer is elastically stretched by roughly 8%.

26. The method as claimed in claim 24, wherein the partial connecting of the second material layer and the third material layer is performed by cementing.

27. The method as claimed in claim 24, wherein the partial connecting of the second material layer and the third material layer is performed by thermal or ultrasonic bonding.
